(19) United States
(12) Patent Application Publication
(10) Pub. No.: US 2017/0187032 A1
(43) Pub. Date: Jun. 29, 2017

(54) SILICON-BASED ACTIVE MATERIAL FOR LITHIUM SECONDARY BATTERY AND PREPARATION METHOD THEREOF

(71) Applicant: KOREA INSTITUTE OF SCIENCE AND TECHNOLOGY, Seoul (KR)

(72) Inventors: Won Young CHANG, Seoul (KR); Byung Won CHO, Seoul (KR); Kyung Yoon CHUNG, Seoul (KR); Si Hyoung OH, Seoul (KR); Young Sun SHIN, Seoul (KR); Sooyeon HWANG, Seoul (KR); Yoon Bong OH, Seoul (KR)

(21) Appl. No.: 15/149,520

(22) Filed: May 9, 2016

(30) Foreign Application Priority Data
Dec. 29, 2015 (KR) 10-2015-0188501

(51) Int. Cl. H01M 4/134; H01M 4/62; H01M 4/1395; H01M 10/0568; H01M 10/0525; H01M 10/0585; H01M 2/16; H01M 10/0569; H01M 4/38; H01M 4/04

(52) U.S. Cl. CPC H01M 4/134; H01M 4/386; H01M 4/624; H01M 4/1395; H01M 4/0402; H01M 4/0471; H01M 4/625; H01M 4/622; H01M 4/382; H01M 10/0525; H01M 10/0585; H01M 2/1653; H01M 10/0569; H01M 10/0568; H01M 2004/027

(57) ABSTRACT

Disclosed is a silicon-based anode active material for a lithium secondary battery. The silicon-based anode active material imparts high capacity and high power to the lithium secondary battery, can be used for a long time, and has good thermal stability. Also disclosed is a method for preparing the silicon-based anode active material. The method includes (A) binding metal oxide particles to the entire surface of silicon particles or portions thereof to form a silicon-metal oxide composite, (B) coating the surface of the silicon-metal oxide composite with a polymeric material to form a silicon-metal oxide-polymeric material composite, and (C) heat treating the silicon-metal oxide-polymeric material composite under an inert gas atmosphere to convert the coated polymeric material layer into a carbon coating layer.

### CROSS-REFERENCE TO RELATED APPLICATIONS

This application claims priority under 35 U.S.C. §119 to Korean Patent Application No. 10-2015-0188501 filed on Dec. 29, 2015 in the Korean Intellectual Property Office, the disclosure of which is incorporated herein by reference in its entirety.

### BACKGROUND OF THE INVENTION

1. Field of the Invention

The present invention relates to a silicon based anode active material for a lithium secondary battery that imparts high capacity and high power to the lithium secondary battery and can be used for a long time, and a method for preparing the same.

2. Description of the Related Art

Silicon-based anode active materials as next-generation anode materials have the potential to replace graphite-based anode active materials due to their higher capacities.

Silicon-based anode active materials bound to lithium (Li_{4.4}Si) exhibit theoretical capacities of 4200 mAh/g, which are higher than those (372 mAh/g, LiC₆) of carbonaceous anode active materials. Silicon-based anode active materials have received attention as next-generation anode active materials due to their high capacities. However, the binding of silicon-based anode active materials to lithium is accompanied by a volume expansion of 300% or above, causing pulverization of the active materials. The pulverized anode active materials fall off from electrode assemblies, causing an increase in irreversible capacity as cycles proceed. As a result, the cycle life of the anode active materials is shortened and the capacity of batteries deteriorates.

Another problem of silicon-based anode active materials is low electrical conductivity, which is responsible for their poor power characteristics compared to carbonaceous active materials.

In attempts to solve such problems, many methods have been proposed to prepare silicon-based anode active materials by simple mixing of silicon with carbonaceous materials or various metals. Other methods are associated with coating, doping, and alloying. Specifically, conventional silicon-based anode active materials are prepared by covering the surface of silicon particles with a coating layer made of a non-graphite carbonaceous material (Japanese Patent Publication No. 2004-259475), mixing graphite particles with silicon particles or a lithium powder (U.S. Pat. No. 5,888,430), micronizing a general purpose silicon metal power under a nitrogen atmosphere and mixing the fine silicon particles with graphite (Yoshio, M. et al., J. of Power Sources, 136 (2004) 108), and mixing fine silicon particles with carbon and covering the carbon by pyrolytic vapor deposition (M. Yamada et al., Hitachi Maxell Ltd., Japan). An amorphous Si—C—O anode material prepared by a sol-gel method (T. Morita, Power Supply & Devices Lab., Toshiba Co., Japan) and an anode material prepared by mechanical alloying of silicon, graphite, and metal (Ag, Ni, Cu) (S. Kugino et at., Dept. of Applied Chem. Saga Univ., Japan) are also known. Other conventional silicon-based anode active materials are prepared by electroless copper plating on the surface of general purpose silicon particles (J. W. Kim et al., Seoul National Univ., Korea), doping chromium (Cr) into n-type silicon to achieve improved conductivity and cyclic stability (Dept. of Applied Chem., Oita Univ., Japan), growing silicon dioxide on the surface of silicon particles and coating carbon thereon (Chem. Commun., 46, 2590, 2010), producing a composite of silicon particles, monodisperse silica, and a carbon coating (J. Power Sources, 195, 4304, 2010 and Bull. Korean. Chem. Soc., 31, 1257, 2010), and fabricating a silicon-zirconia nanocomposite film by the sol-gel process (Electrochemistry communications, 8, 1610, 2006).

However, these methods require complicated processes, have difficulty in preparing commercially available silicon-based anode active materials, and entail high costs. The electrical conductivities of anode active materials prepared by the methods are not high enough to meet charge/discharge requirements and the capacities and cyclabilities of batteries using the anode active materials tend to decrease during repeated charging/discharging reactions of the batteries. Thus, there is a need for new silicon-based anode active materials that do not suffer from the above problems even when silicon particles are used.

### PRIOR ART DOCUMENTS

### Patent Documents

Japanese Patent Publication No. 2004-259475

U.S. Pat. No. 5,888,430

### Non-Patent Documents

J. of Power Sources, 136, 108, 2004

Chem. Commun., 46, 2590, 2010

J. Power Sources, 195, 4304, 2010

Bull. Korean. Chem. Soc., 31, 1257, 2010

Electrochemistry communications, 8, 1610, 2006

### SUMMARY OF THE INVENTION

One object of the present invention is to provide a silicon-based anode active material for a lithium secondary battery that imparts high capacity and high power to the lithium secondary battery and can be used for a long time.

A further object of the present invention is to provide a method for preparing the anode active material.

Another object of the present invention is to provide a lithium secondary battery using the anode active material.

Still another object of the present invention is to provide a system including the lithium secondary battery.

According to one aspect of the present invention, a method for preparing a silicon-based anode active material for a lithium secondary battery includes (A) binding metal oxide particles to the entire surface of silicon particles or portions thereof to form a silicon-metal oxide composite, (B) coating the surface of the silicon-metal oxide composite with a polymeric material to form a silicon-metal oxide-polymeric material composite, and (C) heat treating the silicon-metal oxide-polymeric material composite under an inert gas atmosphere to convert die coated polymeric material layer into a carbon coating layer.

In step (A) the silicon particles and the metal oxide particles may be used in a weight ratio of 5:1 to 110:1.

In step (A), the metal oxide particles may be particles of at least one metal oxide selected from the group consisting of SiO₂, ZrO₂, Al₂O₃, SnO₂, ZnO, and MgO.

In step (B), the polymeric material may be polyvinylidene fluoride-co-hexafluoropropylene, polymethyl methacrylate, polyacrylonitrile, polyaniline, sucrose, polyimide, polyvinyl alcohol, polyvinyl chloride, an epoxy resin, citric acid, a phenol-resorcinol-formaldehyde resin, a phenol-formaldehyde resin or a mixture thereof.

In step (B), the silicon-metal oxide composite and the polymeric material may be used in a weight ratio of 1:99 to 99:1.

In step (C), the heat treatment may be performed while raising the temperature from T1 to T2, T1 may be a temperature between 70 and 90° C., and T2 may be a temperature between 600 and 900° C.

In step (C), the heat treatment may be performed while raising the temperature to T2 at a rate of 3 to 10° C./min and maintaining the same temperature for 1 to 10 hours and T2 may be a temperature between 600 and 900° C.

In step (C), the silicon-metal oxide-polymeric material composite may be dried at T1 before heat treatment and T1 may be a temperature between 70 and 90° C.

In step (C), the inert gas may be helium gas, argon gas, nitrogen gas, neon gas or a mixed gas of two or more thereof.

According to a further aspect of the present invention, a silicon-based anode active material for a lithium secondary battery includes: a silicon-metal oxide composite in which metal oxide particles are coated on the entire surface of silicon particles or portions thereof; and a carbon coating layer coated on the surface of the silicon-metal oxide composite.

The metal oxide particles may be particles of at least one metal oxide selected from the group consisting of SiO₂, ZrO₂, Al₂O₃, SnO₂, ZnO, and MgO.

According to another aspect of the present invention, a lithium secondary battery includes a cathode including a cathode active material, an anode including the silicon-based anode active material and a binder, a separator for preventing short-circuiting between the cathode and the anode, and an electrolyte including a lithium salt.

The binder may be selected from the group consisting of polyacrylic acid, styrene-butadiene rubber (SBR), acrylonitrile-butadiene rubber (NBR), butadiene rubber, isoprene rubber, polysulfide rubber, chloroprene rubber, polyurethane rubber, silicone rubber, ethylene propylene diene methylene (EPDM), acrylic rubber, fluoroelastomers, and mixtures thereof.

The anode may further include a conductive carbon material, a conductive metal or a conductive polymer as a conductive material.

The lithium salt may be selected from the group consisting of LiPF₆, LiBF₄, LiClO₄, LiCF₃SO₃, LiSbF₆, LiAsF₆, and mixtures thereof.

According to yet another aspect of the present invention, a transport system or an energy storage system includes the lithium secondary battery.

The silicon-metal oxide-carbon composite of the present invention does not undergo volume expansion, the formation of an unstable solid electrolyte interface (SEI) as a passivation film on the electrode surface, active material pulverization, and low electrical conductivity during charge/discharge, which are the problems encountered in conventional silicon-based anode active materials. Specifically, the silicon-metal oxide-carbon composite of the present invention forms a stable solid electrolyte interface (SEI) during charge/discharge due to the presence of the carbon coating layer. The SEI formation brings about increased charge/discharge efficiency and cycle efficiency and improved electrical conductivity of a secondary battery. In addition, the carbon coating layer formed by carbon coating on the surface of the silicon-metal oxide composite can be kept stable because the silicon-metal oxide composite structure suppresses volume expansion during charge/discharge.

Furthermore, the anode active material of the present invention has high capacity retention, can be prepared in a simple and economical manner, and has high performance. Therefore, the use of the anode active material enables the fabrication of lithium secondary batteries with improved performance on a large scale.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 diagrammatically shows (a) the binding of metal oxide particles to a silicon particle in accordance with one embodiment of the present invention, (b) the coating of a polymeric material on the surface of the silicon-metal oxide composite in accordance with one embodiment of the present invention, and (c) a silicon-metal oxide-carbon composite as an anode active material prepared by a method according to one embodiment of the present invention;

FIG. 2 shows TEM image of (a) silicon particles, (b) silicon dioxide particles, and (c) zirconia particles;

FIG. 3 shows TEM images at different magnifications of (a) and (b) a silicon-silicon dioxide-carbon composite prepared in Example 1 and (c) and (d) a silicon-zirconia-carbon composite prepared in Example 2; and

FIGS. 4a to 4c are graphs showing charge/discharge characteristics of half cells fabricated in Examples 1-2 and Comparative Example 1.

### DETAILED DESCRIPTION OF THE INVENTION

The present invention is directed to a silicon-based anode active material for a lithium secondary battery that imparts high capacity and high power to the lithium secondary battery and can be used for a long time, and a method for preparing the anode active material.

The present invention has been made in an effort to solve the problems of volume expansion and low electrical conductivity encountered in conventional silicon-based anode active materials.

The present invention will now be described in detail.

The present invention provides a method for preparing an anode active material for a lithium secondary battery, including (A) binding metal oxide (MOx) particles to the entire surface of silicon particles or portions thereof to form a silicon-metal oxide composite ((a) of FIG. 1), (B) coating the surface of the silicon-metal oxide composite with a polymeric material to form a silicon-metal oxide-polymeric material composite ((b) of FIG. 1), and (C) heat treating the silicon-metal oxide-polymeric material composite under an inert gas atmosphere to convert the coated polymeric material layer into a carbon coating layer ((c) of FIG. 1).

First, in step (A), metal oxide (MOx) particles are allowed to physically bind to the entire surface of silicon particles or portions thereof to form a silicon-metal oxide composite.

This physical binding is accomplished by ball milling. Many small pores are formed in the structure of the silicon-metal oxide composite. The pore formation shortens the migration distance of lithium, resulting in improvements in the rate characteristics and charge/discharge cyclability of the lithium secondary battery. The physical binding between the silicon particles and the metal oxide particles enables the formation of the composite and can suppress volume expansion, which is a structural change arising during charge/discharge, to improve the life and rate characteristics of the battery, leading to improvements in the capacity and cycle life of the secondary battery.

The silicon particles are bound to the metal oxide particles in a weight ratio in the range of 5:1 to 110:1, preferably 15:1 to 20:1. If the ratio of the weight of the silicon particles to the weight of the metal oxide particles is outside the range defined above, satisfactory thermal properties and structural stability of the lithium secondary battery can be attained but the capacity and cycle performance of the lithium secondary battery deteriorate, and as a result, high capacity and prolonged life cannot be expected.

Any metal oxide (MOx) particles that can bind physically to the silicon particles and easily form pores in the silicon-metal oxide composite may be used without particular limitation. The metal oxide (MOx) particles are preferably particles of at least one metal oxide selected from the group consisting of SiO₂, ZrO₂, Al₂O₃, SnO₂,ZnO, and MgO. SiO₂ or ZrO₂ particles are more preferred due to their better effects.

Next, in step (B), the silicon-metal oxide composite is surface coated with a polymeric material to form a silicon-metal oxide-polymeric material composite.

The silicon-metal oxide composite is mixed with the polymeric material in a weight ratio of 1:99 to 99:1, preferably 70:30 to 99:1. If the ratio of the weight of the polymeric material to the weight of the silicon-metal oxide composite exceeds the upper limit (1:99) defined above, the polymeric material may clog the pores formed in the silicon-metal oxide composite, causing size reduction or disappearance of the pores, and a thick carbon layer may be formed in the subsequent step, causing poor performance of the lithium secondary battery. Meanwhile, if the ratio of the weight of the polymeric material to the weight of the silicon-metal oxide composite is less than the lower limit (99:1) defined above, a non-uniform carbon layer may be formed in the subsequent step, causing poor performance of the lithium secondary battery.

Any polymeric material that can be converted into a carbon coating layer when carbonized by subsequent heat treatment at high temperature may be used without particular limitation. The polymeric material is preferably polyvinylidene fluoride-co-hexafluoropropylene, polymethyl methacrylate, polyacrylonitrile, polyaniline, sucrose, polyimide, polyvinyl alcohol, polyvinyl chloride, an epoxy resin, citric acid, a phenol-resorcinol-formaldehyde resin, a phenol-formaldehyde resin or a mixture thereof

A solution of the polymeric material in an organic solvent is coated on the surface of the silicon-metal oxide composite. The organic solvent is required to have a low point. In this case, a uniform carbon coating layer can be obtained and the solvent can be easily removed in the subsequent step. The organic solvent having a low boiling point may be N-methyl-2-pyrrolidone (NMP), dimethylformamide (DMF), dimethyl sulfoxide (DMSO), ethanol, acetone, water or a mixture thereof.

Next, in step (C), the silicon-metal oxide-polymeric material composite is carbonized by heat treatment under an inert gas atmosphere to convert the coated polymeric material layer into a carbon coating layer, giving a silicon-metal oxide-carbon composite.

Due to the presence of the carbon coating layer, the silicon-metal oxide-carbon composite of the present invention forms a stable solid electrolyte interface (SEI) as a passivation film on the electrode surface and suppresses side reactions during charge/discharge, bringing about increased charge/discharge efficiency and cycle efficiency and improved electrical conductivity. The improved electrochemical properties eventually lead to an improvement in the performance of the lithium secondary battery.

The polymeric material layer may be dried at T1 before carbonization at high temperature. T1 may be a temperature between 70 and 90° C. The polymeric material layer may not be dried at a temperature lower than the lower limit defined above, and as a result, portions of the polymeric material layer may remain uncarbonized in the subsequent step. Meanwhile, the polymeric material may be partially carbonized at a temperature higher than the upper limit defined above, and as a result, the previously carbonized portions may be insufficient in strength when carbonized at high temperature in the subsequent step, causing poor performance of the secondary battery. The drying may be omitted. In this case, T1 is room temperature (25 to 27° C.).

The heat treatment may be performed while raising, the temperature from T1 to T2. Preferably, the heat treatment is performed while raising the temperature from T1 to T2 at a rate of 3 to 10° C./min and maintaining the temperature at T2 for 1 to 10 hours. By the heat treatment, the polymeric material layer is carbonized and converted into a dense carbon coating layer. T2 is a temperature in the range of 600 to 900° C., preferably 750 to 800° C. If T2 is outside the range defined above, a dense and uniform carbon coating layer may not be formed. If the carbonization is continued under heating without maintaining the temperature at T2, the carbon coating layer is insufficient in strength and is not densely formed.

The heat treatment is performed in the presence of an inert gas. If a gas other than an inert gas is used, the polymeric material layer is not carbonized into a carbon coating layer but is converted into an undesired material layer, causing poor performance of the secondary battery.

The inert gas may be helium gas, argon gas, nitrogen gas, neon gas or a mixed gas of two or more thereof.

The present invention also provides a silicon-based anode active material for a lithium secondary battery that can be prepared by the above method. Specifically, the silicon-based anode active material is a silicon-metal oxide-carbon composite including a silicon-metal oxide composite in which metal oxide particles are coated on the entire surface of silicon particles or portions thereof and a carbon coating layer coated on the surface of the silicon-metal oxide composite, as shown in FIG. 1.

The silicon-metal oxide-carbon composite anode of the present invention has long life and good thermal stability compared to a composite in which a carbonaceous material, such as graphite, is directly coated on silicon and is advantageous in terms of electrical conductivity, power, and capacity over a composite in which carbon only is coated on a silicon anode active material.

Conventional anode active materials including a carbon coating layer formed on the surface of silicon undergo excessive volume expansion of the silicon during charge/discharge. This leads to collapse of the carbon coating layer, which fails to perform its original function. In contrast, according to the present invention, the carbon coating layer formed on the surface of the silicon-metal oxide composite can be kept stable because the silicon-metal oxide composite structure suppresses volume expansion during charge/discharge.

The silicon-metal oxide-carbon composite macrostructure (anode active material) of the present invention is synthesized from a nanosized silicon active material as a starting material and has small pores formed therein. This pore formation allows the silicon-metal oxide-carbon composite to have a large specific surface area and a short migration distance of charges, ensuring improved battery characteristics. In addition, improved charge/discharge characteristics and high capacity retention can be achieved, facilitating the fabrication of lithium secondary batteries with improved performance on a large scale.

The following examples are provided to assist in further understanding of the invention. However, these examples are intended for illustrative purposes only. It will be evident to those skilled in the art that various modifications and variations can be made without departing from the scope and spirit of the invention and such modifications and variations are encompassed within the scope of the appended claims.

### EXAMPLE 1

### Silicon-Silicon Dioxide-Carbon Composite

3 g of silicon having an average particle diameter of 100 nm and 0.15 g of silicon dioxide (silicon particles: silicon dioxide particles=20:1, w/w) were subjected to ball milling at 300 rpm for 2 h to form a silicon-silicon dioxide composite. The weight of the beads used was 20 times that of the mixture.

2 g of polyvinylidene fluoride-co-hexafluoropropylene (PVDF) was dissolved in 8 g of acetone with stirring for 12 h. 1 g of the silicon-silicon dioxide composite was mixed with 1.5 g of the PVDF solution. The mixture was homogenized for 12 h.

The silicon-silicon dioxide-PVDF composite dried in an oven at 80° C. for 6 h, heated to 800° C. at a rate of 5° C./min, and heat treated at 800° C. for 3 h, affording a silicon-silicon dioxide-carbon composite. After completion of the reaction, the composite was cooled at the same rate as the heating rate and was collected at room temperature.

### Silicon Electrode

0.3 g of the silicon-silicon dioxide-carbon composite as an anode active material, 0.1 g of Denka Black as a conductive material, 0.28 g of a 35% poly(acrylic acid) (PAA) solution, and 1 g of ethanol were mixed together. The mixture stirred at 4000 rpm for 30 min. The viscosity of the mixture is not limited but is preferably adjusted so as not to be too high or too low for a constant electrode thickness. The resulting slurry was coated on a 10 μm thick copper foil by a doctor blade method to produce a silicon electrode.

### Coin-Type Cell

The anode including the silicon-silicon dioxide-carbon composite was laminated to a lithium metal electrode and a polypropylene (PP) separator was interposed between the two electrodes. 5% fluoroethylene carbonate (FEC) was added to a mixture of ethyl carbonate/ethyl methyl carbonate (EC/EMC, 3:7 (v/v)) as organic solvents and LiPF₆ was dissolved therein to a concentration of 1 M to prepare an electrolyte. The electrolyte was injected into the electrode structure, completing the fabrication of a coin type cell.

The capacities of the coin-type cell were measured during charge and discharge in the voltage range of 0.05-2 V. Changes in the capacity of the coin-type cell were measured at different C-rates.

### EXAMPLE 2

### Silicon-Zirconia-Carbon Composite

3 g of silicon having an average particle diameter of 100 nm and 0.15 g of zirconia (silicon particles: zirconia particles=20:1, w/w) were subjected to ball milling at 300 rpm for 2 h to form a silicon-zirconia composite. The weight of the beads used was 20 times that of the mixture.

2 g of polyvinylidene fluoride-co-hexafluoropropylene (PVDF) was dissolved in 8 g of acetone with stirring for 12 h. 1 g of the silicon-zirconia composite was mixed with 1.5 g of the PVDF solution. The mixture was homogenized for 12 h.

The silicon-zirconia-PVDF composite was dried in an oven at 80° C. for 6 h, heated to 800° C. at a rate of 5° C./min, and heat treated at 800° C. for 3 h, affording a silicon-zirconia-carbon composite. After completion of the reaction, the composite was cooled at the same rate as the heating rate and was collected at room temperature.

An electrode was produced and a cell was fabricated in the same manner as in Example 1, except that the silicon-zirconia-carbon composite was used instead of the silicon-silicon dioxide-carbon composite.

### COMPARATIVE EXAMPLE 1

An electrode was produced and a cell was fabricated in the same manner as in Example 1, except that pristine silicon was used as an anode active material instead of the silicon-silicon dioxide-carbon composite.

### TEST EXAMPLES

### Test Example 1

### TEM Imaging

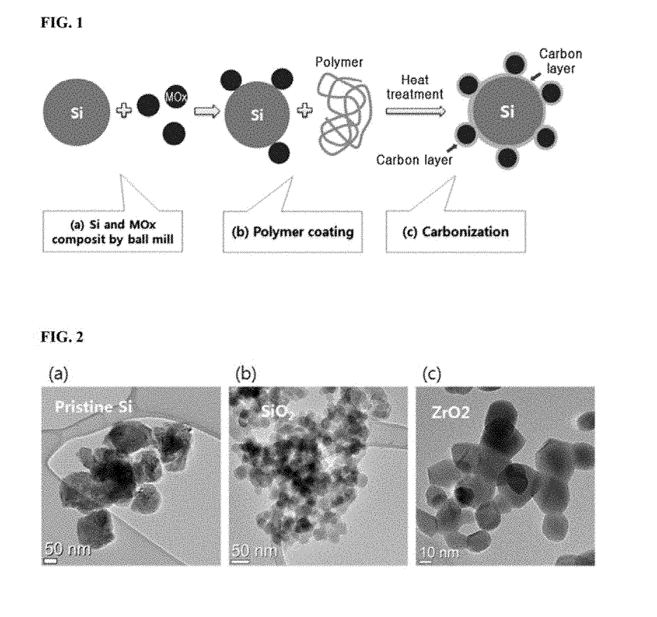

FIG. 2 shows TEM image of the silicon particles (a), the silicon dioxide particles (b), and the zirconia particles (c).

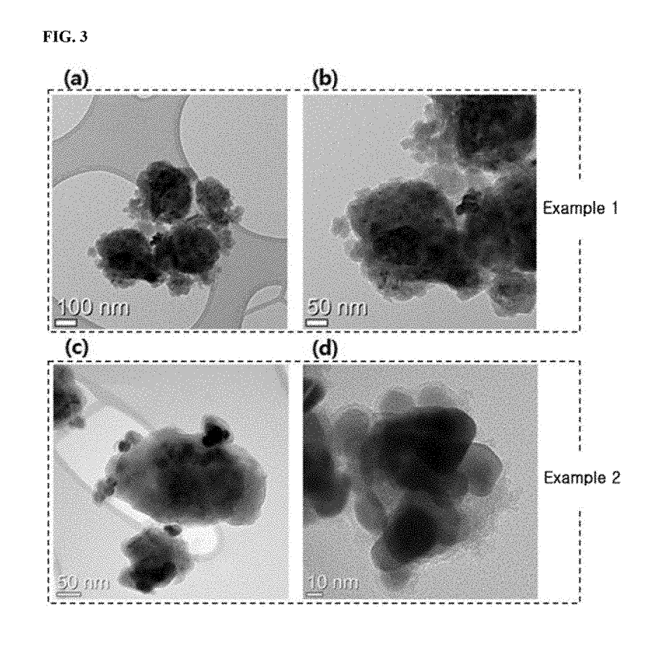

FIG. 3 shows (a) and (b) TEM images of the silicon-silicon dioxide-carbon composite prepared in Example 1, which were taken at different magnifications to determine whether the carbon coating layer was successfully formed in the composite. FIG. 3 also shows (c) and (d) TEM images of the silicon-zirconia-carbon composite prepared in Example 2, which were taken at different magnifications to determine whether the carbon coating layer was successfully formed in the composite.

In the silicon-silicon dioxide-carbon composite shown in (a) and (b) of FIG. 3, the carbon layer was coated on the silicon-silicon dioxide composite formed by physical binding between the silicon particles ((a) of FIG. 2) and the silicon dioxide particles ((b) of FIG. 2). As shown in (a) and (b) of FIG. 3, the carbon layer was uniformly coated on the silicon-silicon dioxide composite.

In the silicon-zirconia-carbon composite shown in (c) and (d) of FIG. 3, the carbon layer was coated on the silicon-zirconia composite formed by physical binding between the silicon particles ((a) of FIG. 2) and the zirconia particles ((c) of FIG. 2). As shown in (c) and (d) of FIG. 3, the carbon layer was uniformly coated on the silicon-zirconia composite.

### Test Example 2

### Charge/Discharge Characteristics

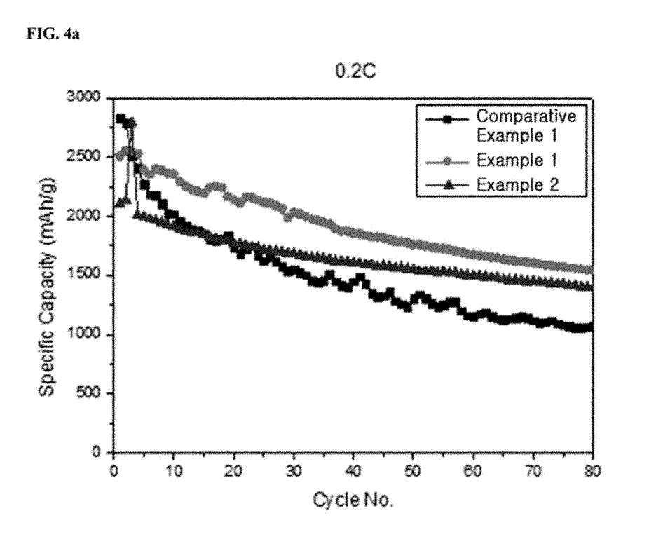

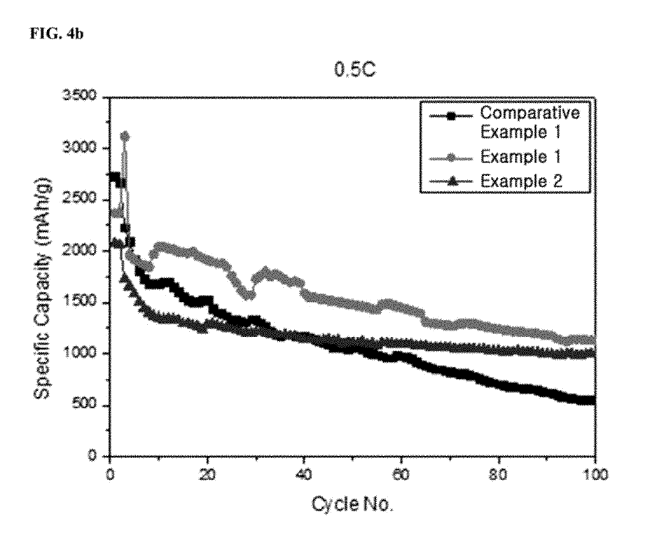

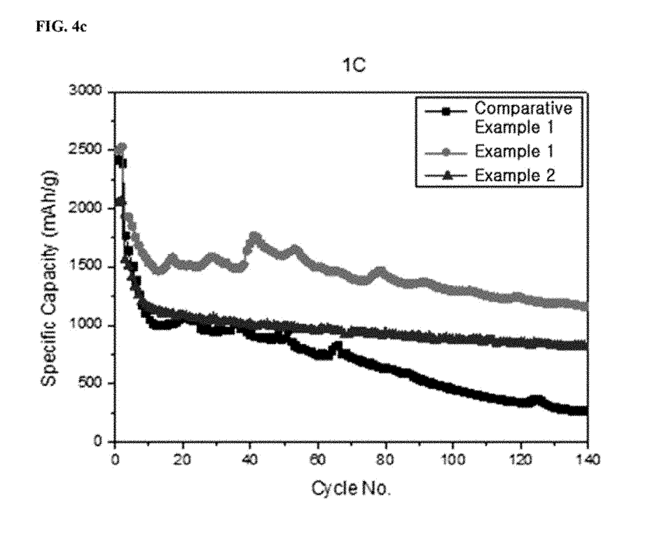

FIGS. 4a to 4c are graphs showing charge/discharge characteristics of the half cells fabricated in Examples 1-2 and Comparative Example 1. Specifically, FIGS. 4a to 4c show the discharge capacities of the cells measured after 80 cycles of <0.2C, 0.2D>, <0.5C, 0.5D>, and <1C, 1D>, respectively, to determine the tendency of the rate characteristics of the cells. In order to test the rate characteristics, the cyclabilities of the cells were measured at different C-rates (0.2C, 0.5C, and 1C-rates) after 2 initial cycles of charge/discharge at 0.05C and 2 cycles of charge/discharge at 0.1C (FIGS. 4a, 4b, and 4c, respectively).

FIGS. 4a to 4c reveal that the cells of Examples 1 and 2 had excellent charge/discharge characteristics compared to the cell of Comparative Example 1. Particularly, the cell of Example 1 was confirmed to have excellent charge/discharge characteristics compared to the cell of Example 2.

These results demonstrate that the silicon dioxide and zirconia particles bound to the surface of the silicon particles act as buffer matrices to suppress the occurrence of volume expansion of the silicon during charge/discharge, leading to excellent charge/discharge characteristics of the cells of Examples 1 and 2.

1. A method for preparing a silicon-based anode active material for a lithium secondary battery, the method comprising (A) binding metal oxide particles to the entire surface of silicon particles or portions thereof to form a silicon-metal oxide composite, (B) coating the surface of the silicon-metal oxide composite with a polymeric material to form a silicon-metal oxide-polymeric material composite, (C1) drying the silicon-metal oxide-polymeric material composite at T1 before the step (C2), and (C2) heat treating the silicon-metal oxide-polymeric material composite from the T1 to T2 under an inert gas atmosphere, thereby converting the coated polymeric material layer into a carbon coating layer,
wherein the T1 is a temperature between 70° C. and 90° C. and the T2 is a temperature between 600° C. and 900° C.,
wherein the heat treatment is performed by raising the temperature at a rate of 3 to 10° C./min and maintaining the same temperature for 1 to 10 hours.

2. The method according to claim 1, wherein in step (A), the silicon particles and the metal oxide particles are used in a weight ratio of 5:1 to 110:1.

3. The method according to claim 1, wherein in step (A), the metal oxide particles are particles of at least one metal oxide selected from the group consisting of SiO₂, ZrO₂, Al₂O₃, SnO₂, ZnO, and MgO.

4. The method according to claim 1, wherein in step (B), the polymeric material is polyvinylidene fluoride-co-hexafluoropropylene, polymethyl methacrylate, polyacrylonitrile, polyaniline, sucrose, polyimide, polyvinyl alcohol, polyvinyl chloride, an epoxy resin, citric acid, a phenol-resorcinol-formaldehyde resin, a phenol-formaldehyde resin or a mixture thereof.

5. The method according to claim 1, wherein in step (B), the silicon-metal oxide composite and the polymeric material are used in a weight ratio of 1:99 to 99:1.

6-8. (canceled)

9. The method according to claim 1, wherein in step (C2), the inert gas is helium gas, argon gas, nitrogen gas, neon gas or a mixed gas of two or more thereof.
